(19) United States
(12) Patent Application Publication
(10) Pub. No.: US 2003/0161854 A1
(43) Pub. Date: Aug. 28, 2003

(54) Synergistic formulations

(76) Inventors: Lionel Barry Lowe, New South Wales (AU); James Terence Rothwell, New South Wales (AU)

Correspondence Address: ELI LILLY AND COMPANY, PATENT DIVISION, P.O. BOX 6288, INDIANAPOLIS, IN, 46206-6288, US

(21) Appl. No.: 10/239,325

(22) PCT Filed: Mar. 20, 2001
(86) PCT No.: PCT/AU01/00306

(30) Foreign Application Priority Data
Mar. 20, 2000 (AU) PQ 6343

(51) Int. Cl. A01N 43/04; A01N 25/00

(52) U.S. Cl. 424/405; 514/28

(57) ABSTRACT

The present invention relates to an active composition for controlling or eradicating Diptera pests in domestic animals or their environs, comprising a synergistic combination of at least one A83543 compound and at least one macrocyclic lactone. The invention also relates to the use of the active composition in pesticidal formulations, the formulations themselves and to the various applications of those formulations as pesticides, specifically in controlling all species of Diptera pests in domestic animals or their environs. Such applications include the control of such external Diptera pests in domestic animals including but not limited to sheep, cattle, poultry, pigs, goats, camelids, horses, dogs and cats, and also the household and rural applications of such formulations in control of such pests.

### TECHNICAL FIELD

The present invention relates to combinations of pesticidally active compounds suitable for use as active agents in pesticidal formulations, the formulations themselves and to the various applications of those formulations as pesticides, specifically in controlling all species of Diptera pests. Such applications include the control of such external Diptera pests in domestic animals including but not limited to sheep, cattle, poultry, pigs, goats, camelids, horses, dogs and cats, as well as the household and rural applications of such formulations in control of such pests.

### BACKGROUND OF THE INVENTION

Historically, the greatest damage to domestic animals and crops has been caused and continues to be caused by pests such as insects, fungi, nematodes and microbes.

Insects particularly represent a cause for concern as they are the most numerous of all living organisms and constitute approximately 72% of all animal species. Approximately 1% of insects are considered pests in that they attack humans and/or domestic animals, transmit human, animal and plant diseases, destroy crops, objects and structures and compete for food and other necessities. It is estimated that enormous agricultural losses result worldwide from insect presence.

Domestic animals which include animals of agricultural worth such as sheep, cattle, horses, goats, pigs and other ruminants and monogastrics are almost invariably subject to the activity of pests including insects, mites, acarides, acarina, siphonaptera, anoplura and maltophaga. External parasites such as flies, ticks, lice and fleas irritate the animals and can cause economic loss in the form of poor quality hide, wool or sheep skin, poor quality meat/tissue, reduced weight gain and even death as a result of the animal carrying harmful parasites.

The losses resulting from insect caused human and animal diseases are also enormous. In fact, insects are considered to be the carriers of more than 250 viruses which are pathogens of humans and higher animals. The numbers of human deaths caused by mosquito transmitted diseases such as malaria and lymphatic filariasis are huge. Flies also transmit human and animal related diseases such as trachoma, trypanosomiasis and river blindness.

However, out of the nearly one million species of arthropods which includes lice, ticks, flies and mites, only a small percentage require the application of control measures. To date, the primary method for controlling insects and other pests, particularly in respect of domestic animals (such as sheep, cattle, goats, horses and hogs) has been by the application of synthetic chemical pesticide compositions. It is estimated that there are at least 35,000 formulated pesticide products worldwide with chemicals as the active ingredients. Such pesticide products include antimicrobials, larvicides, insecticides, animal dips, avicides and disinfectants.

The extensive use of chemical insecticides since the 1940s has resulted in a large number of problems including widespread insect resistance, emergence of secondary pests, hazards to human and animal health as well as detrimental effects on fish and birds, environmental pollution and the increasing economic costs of new insecticides.

Many insect species have developed resistance to the action of specific insecticides so as to necessitate changes in control practices. There is an ever-widening pool of insect pests which are developing multiple resistance. The resistance genes having lengthy persistence in insect genomes which preclude successful reuse of an insecticide to control an insect population with resistant genes.

Pesticide/insecticide residues and their consequential many potential human, animal and environmental risks are also seen as one of the major problems resulting from chemical usage, particularly those formulations containing active agents which include organophosphates or synthetic pyrethroids. With the exception of microbial insecticides, nearly all pesticides result in residues of various chemicals and their degradation products or metabolites which may be present in detectable amounts (ppb to ppm) in food despite food processing. Tissue/meat residues are also a major concern when considering use of insecticides on farm animals.

Potential human risks from the use of such insecticides include acute toxic reactions to the insecticide such as poisoning, skin and eye irritations, as well as possible long term effects such as cancer, birth defects, and reproductive disorders.

Acute inhalation toxicity as well as dermal penetration are also potential risks. Health hazards in humans may also arise from repeated exposure to a chemical over a limited period of time.

In particular, the currently used actives of synthetic pyrethroids and organophosphates which are commonly used in insecticidal formulations to control lice and flies, particularly on sheep, are not only toxic to animals but also to the human operator who applies them. Exposure in farmers or operators who handle both pesticide concentrates and the larger volumes of pesticide diluted for use, is a cause for concern. Further, it is possible for the operator to ingest pesticides not only by mouth, but also by breathing (eg spray drift) and by absorption through the skin (accidental spillage). Of particular concern has been the use of organophosphates where accidental exposure causes acute and chronic poisoning affecting the nervous system.

Accordingly, insect and other pest control has been sought to be directed away from exclusive reliance on insecticides and towards the optimisation of environmental and economic insect and pest control (integrated pest management). The application of microbial control in which insects are attacked by pathogens such as viruses, bacteria, fungi and protozoa are favoured as such microbial insecticides are highly selective for insect pests and do not leave toxic residues. However, such microbial insecticides are not without their problems such as the difficulty in applying as well as confining the natural enemy/parasite/disease to a large area. Further, they also have the disadvantage of short residual action and extreme specificity which limits general applicability.

Biological control has been recently applied in the area of insecticides/pesticides through the release of sterilised male insects. Genetic engineering has also recently been applied by way of mass introduction of deleterious mutations such as chromosomal translocations. However, such procedures are very expensive and stringent criteria are required before release of sterile males is contemplated. Chemosterilants which sterilise large segments of insect pest populations are also known but are strong carcinogens which precludes their use.

The use of chemical insecticides and pesticides and their environmental and economic viability, the dangerous nature and magnitude of the persisting residues as well as increasing insect and pest resistance, together with high toxicity levels of many chemical insecticides, has resulted in the search for new substances or approaches to insect and other pest control.

There is therefore a need for compounds and combinations thereof which can be used as active agents in pesticides, particularly against insects which afflict domestic animals or their environs, and which are effective at low application rates, selective in biologic action and have low toxicity and a high margin of safety to humans, crops, economic animals, aquatic organisms and birds. Such compounds and combinations must be both environmentally friendly in that there must be demonstrably low impacts on the environment, as well as economically viable to use on a large scale. Further, there must be none or little insect resistance to such compounds or combinations.

Fermentation product A83543, also known as spinosyn, includes a family of related compounds (spinosyns) produced by Saccharopolyspora spinosa. These are naturally derived fermentation products with a positive safety profile in contrast to currently used synthetic organically derived compounds (such as synthetic pyrethroids, organophosphates, organochlorines and carbamates), and have previously been shown to exhibit excellent insecticidal activity. Accordingly by the term “A83543 compounds” which has the same scope as the phrase “spinosyn and derivatives and analogues thereof” is meant components consisting of a 5,6,5-tricyclic ring system, fused to a 12-membered macrocyclic lactone, a neutral sugar (2N,3N,4N-tri-O-methylrhamnose) and an amino sugar (forosamine). The family of natural components of A83543 include a genus taught in EPO patent application No. 0375316 and having the following general formula:

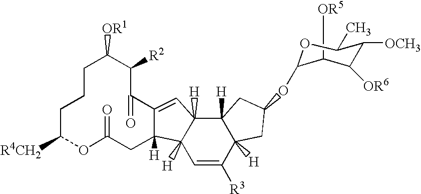

wherein R¹ is H or a group selected from

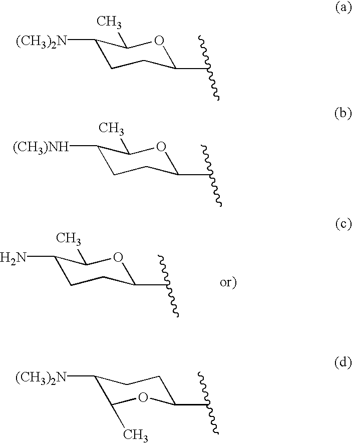

and R², R⁴, R³, R⁵ and R⁶ are hydrogen or methyl; or an acid addition salt thereof when R¹ is other than hydrogen.

The family of compounds from A83543 fermentation product has been shown to comprise individual compounds A83543A, A83453B, A83543C, A83453D, A83543E, A83453F, A83543G, A83453H, A83543J, A83453L, A83543M, A83453N, A83543Q, A83453R, A83543S, A83453T, A83453U, A83543V, A83453W, A83453X. Boeck et al. described spinosyns A-H and J and salts thereof in U.S. Pat. Nos. 5,362,634, 5,496,932 and 5,571,901 which are incorporated herein by reference. Mynderse et al. described spinosyns L-N, their N-demethyl derivatives and salts thereof in U.S. Pat. No. 5,202,242 incorporated herein by reference. Turner et al. described spinosyns Q-T, their N-demethyl derivatives and salts thereof in U.S. Pat. Nos. 5,591,606, 5,631,155 and 5,767,253 which are also incorporated herein by reference. Spinosyns K, O, P, U, V, W, and Y are described in the article by DeAmicis, C. V. et al. in American Chemical Society's Symposium Series: Phytochemicals for Pest Control (1997), Chapter 11 “Physical and Biological Properties of Spinosyns: Novel Macrolide Pest-Control Agents from Fermentation pp146-154.

Spinosyn A (A83543A) was the first spinosyn isolated and identified from the fermentation broth of Saccharapolyspora spinosa. Subsequent examination of the fermentation broth revealed that the parent strain of S.spinosa produced a number of spinosyns (A83543A to J). Compared to spinosyn A, spinosyns B to J are characterised by differences in the substitution patterns on the amino group of the forosamine, at selected sites on the ring system and on the neutral sugar. The strains of S.spinosa produce a mixture of spinosyns which primary components are spinosyn A (˜85%) and spinosyn D (˜15%). These are the two spinosyns that are currently known as the most active as insecticides.

Similar to the spinosyns, macrocyclic lactones have also previously been shown to exhibit excellent insecticidal activity. Macrocyclic lactones have a complex ring structure and include such well known anthelmintic compounds as avermectins and milbemycins. The avermectins are isolated from fermentation products of Streptomyces avemitilis and ivermectin is a compound which is a semisynthetic chemical formed by modification of avermectin. The basic structure of the avermectins is a 16-membered lactone ring to which are appended three main substituent groups: a hexahydrobenzofuran group, a disaccharide group (at C-13) and a spiroketal ring (C-17 to C-28). Doramectin is a novel avermectin. Milbemycins are other compounds which are not avermectins but which can be considered to come within the class of compounds which are macrocyclic lactones. The milbemycins differ structurally from the avermectin group, mainly in the absence of a disaccharide group on C-13. Moxidectin is derived from the fermentation product nemadectin and possesses a methoxime substituent on C-23.

The present invention resides in the discovery of a synergistic combination of pesticidal compounds, the formulation and application of specific pesticidally active agents based on the synergistic combination and their use in pesticidal formulations against Diptera pests, particularly in domestic animals.

### OBJECTS OF THE INVENTION

Accordingly, it is an object of this invention to provide a pesticidal composition active against Diptera pests in domestic animals including cattle, camellids, pigs, dogs, horses, cats, sheep, goats, poultry or their environs, containing a synergistic combination of at least one A83543 compound and at least one macrocyclic lactone.

Accordingly, it is another object of this invention to provide one or more pesticidal formulations active against Diptera pests in domestic animals including cattle, camellids, pigs, horses, dogs, cats, sheep, goats, poultry or their environs, containing a synergistic combination of at least one A83543 compound and at least one macrocyclic lactone as the active principles together with at least one acceptable carrier or diluent.

It is also an object of the present invention to provide a method of eliminating and/or controlling Diptera pests in domestic animals including cattle, camellids, pigs, horses, dogs, cats, sheep, goats, poultry or their environs by applying or administering to said animals or their environs a pesticidally active combination of compounds alone or together with an acceptable carrier or diluent.

It is also an object of the present invention to provide a method of eliminating and/or controlling Diptera pests in environs of domestic animals including household and rural structures such as farm houses, poultry sheds and dairy sheds by applying an insecticidally/pesticidally active combination of compounds alone or together with an acceptable carrier or diluent.

The term ‘Diptera’ or ‘Diptera pests’ as used herein defines members of the insect order Diptera, which are parasitic during one or more stages of their life cycle, including the larval stage, the adult stage or both stages and further includes Diptera insect eggs.

It is further noted that for the purposes of the present application, the term ‘spinosyn or analogue or derivative thereof’ is defined to include an individual spinosyn factor (A83543A-H, J-W or Y) an N-demethyl or other derivative of an individual spinosyn factor, or salt thereof, or a combination thereof, consistent with the disclosure of the abovementioned references which have been incorporated herein. As stated above, the term “A83543 compound” is used herein to mean an individual spinosyn factor, or an analogue, a derivative or salt thereof, or a combination thereof.

The term ‘controlling or eradicating’ is used to refer to a decrease in the number of living insects (adult or larval forms) or to a decrease in the number of viable insect eggs. The extent of reduction somewhat depends on the application rate and the active used.

The term ‘effective amount’ also used herein means the amount which is sufficient to cause a measurable reduction in the treated insect population.

The word ‘carrier’ is used throughout the present specification to include carrier blends, that is mixtures of more than one substance.

The term ‘synergistic’ as used herein is defined to mean a combination of components wherein the activity of the combination is greater than the additive of the individual activities of each component of the combination.

The term ‘macrocyclic lactone’ as used herein is defined to be compounds of the classes of milbemycins and avermectins.

The term ‘domestic animal’ as used herein is defined to include animals of agricultural worth and companion animals, including but not limited to cattle, camellids, pigs, dogs, cats, sheep, poultry, horses and goats a well as other ruminants and monogastrics.

The term ‘environs of domestic animals ’ is defined to include any environment or structure where domestic animals may be located in or in reasonable proximity to, such as farmyard structures, dairy sheds, poultry sheds, stables, farmhouses, dog and cat kennels, houses where dogs and cats are kept, pig sties and shearing sheds.

### SUMMARY OF THE INVENTION

A first aspect of the present invention provides an active composition for controlling or eradicating Diptera pests in domestic animals or their environs, said composition being a synergistic combination of at least one A83543 compound and at least one compound which is a macrocyclic lactone.

A second aspect of the present invention provides a formulation for controlling or eradicating Diptera pests in domestic animals or their environs, said formulation including an effective amount of an active composition of the first aspect of the invention and an acceptable carrier, diluent or excipient.

A third aspect of the present invention provides an externally applied formulation for control or eradication of Diptera pests in domestic animals, said formulation including an effective amount of an active composition of the first aspect of the invention and an acceptable carrier.

A fourth aspect of the present invention provides a formulation for control or eradication of Diptera pests in the environs of domestic animals, said formulation including an effective amount of an active composition of the first aspect of the invention and an acceptable carrier.

A fifth aspect of the present invention provides a method of controlling or eradicating Diptera pests in domestic animals or their environs, said method including the external application of an effective amount of an active composition according to the first aspect of the invention, or of a formulation according to the second or third aspects of the invention to a localised area of the external surface of said animal or to the environs of said animal.

A sixth aspect of the present invention provides a method of controlling or eradicating Diptera pests in the environs of domestic animals, said method including the application of an effective amount of an active composition according to the first aspect of the present invention, or of a formulation according to the second or fourth aspects of the invention to a surface area of the environs.

Another aspect of the present invention provides the use of an active composition of the first aspect of the present invention in the manufacture of a medicament for controlling or eradicating Diptera pests in domestic animals or their environs.

Another aspect of the present invention provides an active composition of the first aspect of the present invention or a formulation of the second, third or fourth aspects of the present invention when used for controlling or eliminating Diptera pests in domestic animals or their environs.

This invention is predicated upon the surprising discovery of a synergistic interaction between spinosyns and macrocyclic lactones (avermectins/milbemycins). Whilst not wishing to be bound by theory, it is noted that macrocyclic lactones have a primary effect on the insect nervous system by activating inhibitory glutamate receptors, while spinosyns primarily activate the nicotinic acetylcholine receptors in insect neurones causing hyperactivity of neurones. However, both spinosyns and macrocyclic lactones have a secondary effect on gamma aminobutyric acid (GABA) gated chloride channels in insect neurones, GABA being an inhibitory neuro-transmitter. It is therefore possible that when combined together the spinosyns and macrocyclic lactones have a synergistic effect on the GABA receptor leading to effects in an insect's nervous system, this being unrelated to the primary effect of either spinosyns or macrocyclic lactones.

Typically, the first aspect of the present invention provides an active composition for control or eradication of Diptera pests in domestic animals or their environs, being a synergistic combination of a spinosyn and a macrocyclic lactone compound, wherein the spinosyn: macrocyclic lactone compounds are present in the range of 10:1 to 1:10 w/w.

Typically, in the active composition of the invention, the spinosyn compound: macrocyclic lactone compound are present in the range of 9:1 to 1:9 w/w.

More typically, in the active composition of the invention, the spinosyn compound: macrocyclic lactone compound are present in the range of 8:1 to 1:8 w/w.

Also typically, in the active composition of the invention, the spinosyn compound: macrocyclic lactone compound are present in the range of 7:1 to 1:7 w/w.

Also typically, in the active composition of the invention, the spinosyn compound: macrocyclic lactone compound are present in the range of 6:1 to 1:6 w/w.

More typically, in the active composition of the invention, the spinosyn compound: macrocyclic lactone compound are present in the range of 5:1 to 1:5 w/w.

Even more typically, in the active composition of the invention, the spinosyn compound: macrocyclic lactone compound are present in the range of 4:1 to 1:4 w/w.

Most typically, in the active composition of the invention, the spinosyn compound: macrocyclic lactone compound are present in the range of 3:1 to 1:3 w/w.

One embodiment of the first aspect of the present invention provides an active composition being a synergistic combination of spinosad and an avermectin.

Typically, the macrocyclic lactone of the first aspect of the invention is selected from the group consisting of ivermectin, abamectin, avermectin A₁ₐ, avermectin A_{1b}, avermectin A₂ₐ, avermectin A_{2b}, avermectin B₁ₐ, avermectin B_{1b}, avermectin B₂ₐ, avermectin B_{2b}. Also typically, the macrocyclic lactone of the first aspect of the invention can include moxidectin, doramectin, selamectin, eprinomectin and milbemycin.

More typically, the macrocyclic lactone of the first aspect of the invention is ivermectin.

More typically, the active composition is therefore a synergistic combination of spinosad and ivermectin.

Typically in the formulations of the present invention, the carrier is non-aqueous or aqueous and the active composition is suspended, dissolved or dispersed in the carrier. Preferably, the carriers or excipients used in the formulations of the invention include dust carriers, solvents, emulsifiers, wetting and dispersing agents and water. Selection of the carrier is of course made on the basis of compatibility with the active composition, including such considerations as pH, moisture content and stability. Selection of the carrier is also made depending on the mode of application of the formulation-such as whether it is to be applied topically to a domestic animal or instead externally applied to a particular environs of such a domestic animal.

One embodiment of the second or third aspects of the invention provides a formulation for controlling or eradicating Diptera pests, said formulation including:

(a) from 0.1 to 40% by weight of an active composition of the first aspect of the present invention, and

(b) from 60-99.9% by weight of a suitable carrier.

Typically each dose of a formulation of the invention would contain 1 mg-1 g of each of the spinosyn compound and macrocyclic lactone compound.

Formulations can also be made up as concentrates and then diluted prior to use.

It has long been common practice to control external parasites on sheep, cattle and other domestic animals including but not limited to goats, pigs and horses by the localised topical application of a formulation containing an active insecticide/parasiticide and a carrier/vehicle. Typically therefore, a formulation of the third aspect of the invention is a pour-on formulation including an effective amount of an active composition of the first aspect of the invention and a topically acceptable carrier.

It is also typical that a topically applied formulation can be a spray or dip or a solution such as a jetting fluid.

A pour-on formulation of the third aspect of the present invention is typically liquid and is usually applied to the exterior of a domestic animal as a line or a spot, which then acts to protect the external surface of the animal against both larval and adult forms of Diptera pests such as flies and mosquitoes and can also act to decrease the number of viable Diptera insect eggs.

While the formulation is applied topically, to a localised area, the active agent migrates over the surface of the animal to protect its whole external surface area.

The carrier (also referred to herein as ‘vehicle’) present in such pour-on formulations of the third aspect of the present invention is formulated to achieve good spread around the skin and/or penetration of the epidermis of the animal. To date, commercial pour-on formulations are suspensions, emulsifiable concentrates or solutions and are often comprised of at least one organic solvent. Solvents commonly used as carriers in such pour-on formulations include propylene glycol, paraffins, isoparaffins, aromatics, isopropylmyristate (IPM), glycol ethers, alcohols and n-propyl alcohol.

Another embodiment of the third aspect of the invention provides a pour-on formulation for control of Diptera pests in domestic animals, said formulation including:

(a) from 0.1 to 40% by weight of at least one active agent of the first aspect of the present invention, and

(b) from 60-99.9% by weight of a suitable carrier selected from the group consisting of TPM/alcohol, OP/IPM/OSU and GTCC/IMP/CAP where

TPM is Tripropylene glycol methyl ether;

OP is octyl palmitate or 2-ethylhexyl palmitate which is an excellent lubricant, and can also be used as an emollient and a solvent;

OP can be replaced by OS (octyl stearate or 2-ethylhexyl stearate);

IPM is isopropyl myristate which has excellent spreading and emollient properties—this can be used interchangeably with IPP or IPL;

IPP is isopropyl palmitate;

IPL is isopropyl laurate;

PMP is PPG 2 myristyl ether propionate which spreads rapidly and promotes wetting of other materials;

OSU is di-2-ethylhexyl succinate and promotes wetting and spreading of lipophilic substances onto the skin;

ICS is isocetyl stearate which can be used as an emollient, lubricant and spreading agent;

GTCC is glyceryl tri caprylate/caprate which is an excellent carrier or vehicle for actives;

CAP is a selected blend of branched chain esters which again acts as an emollient and spreading agent;

Alcohol could be benzyl alcohol, propyl alcohol, diacetone alcohol or other suitable alcohol.

Typically, the formulations of the present invention, can be in the form of a powder, emulsion, foam paste, aerosol, ointment, salve or gel. More typically, the formulation is a solution, and typically water soluble.

Typically, formulations of the present invention can be effectively applied to domestic animals such as sheep, cattle, goats, camelids, pigs, dogs, cats, poultry and horses, other ruminants and monogastrics; and to the environs of these domestic animals.

Typically a pour-on formulation is applied by pouring in one or several lines or in a spot on the dorsal midline (back) or shoulder of a domestic animal. More typically, the pour-on formulation is applied by pouring along the back of the animal, following the spine. A pour-on formulation can also be applied to the animal by other conventional methods including wiping an impregnated material over at least a small area of the animal, by using commercially available applicators, by means of a syringe, by spraying or by using a spray race.

Typically, approximately about 0.1-2000 mg active composition/kg of animal bodyweight is an effective amount for topical application to domestic animals. Typically, about 2-100 mg of active composition of the first aspect of the present invention will be applied to a cow or sheep (per kg bodyweight).

Typically, a formulation of the present invention, such as a pour-on formulation, is formulated such that the active composition is present in a concentration of about 0.1-40% weight/volume, more typically 0.1-20% weight/volume, preferably about 0.5 to 5% depending on the potency of the active.

Typically, an active composition or a formulation of the present invention is formulated such that each of the A83543 compound and the macrocyclic lactone are present in a concentration range of about 1-500 ppm. This concentration is most typical in respect of ready to use formulations such as diluted dips and sprays.

Typically only a small volume of a pour-on formulation is required in order to be effective against the Diptera pests, such as in the order of 0.5-80 ml per application, with 10-60 ml per application being preferred for larger animals such as cattle and 1-20 ml per application for smaller animals such as sheep, dogs and cats.

In the formulations of the present invention having pesticidal activity against Diptera pests, the active agent is a combination of at least one compound selected from the class of spinosyn compounds (including spinosad) and at least one active agent selected from the macrocyclic lactones including ivermectin, abamectin, moxidectin, doramectin, eprinomectin and milbemycin.

The formulations of the present invention suitably can include one or more additional ingredients such as preservatives, spreading agents, adhesion promoters, active solubilisers such as oleic acid, viscosity modifiers, UV blockers or absorbers, colourants and stabilisers such as antioxidants. Suitably, surface active agents including anionic, cationic, non-ionic and ampholytic surface active agents can also be included in the pour-on formulations of the present invention.

If necessary, some oleic acid to dissolve the active may be required, such as if spinosad is used.

Isopropyl myristate (IPM), isopropyl palmitate (IPP), caprylic/capric acid esters of saturated C₁₂-C₁₈ fatty alcohols, oleic acid, oleyl ester, ethyl oleate, triglycerides, silicone oils and dipropylene glycol mono methyl ether (DPM) are common spreading agents used in pour-on formulations.

Typically, the method of the fifth and sixth aspects of the present invention prevents biting flies, carnivorous flies and other Diptera pest infestations of domestic animals, including but not limited to cattle, sheep, goats, pigs, horses, camelids, dogs, cats and poultry and other ruminants and monogastrics, and their environs.

Typically, the active compositions, formulations and methods of the present invention are effective against larval and adult forms of Diptera pests in domestic animals as well as their environs. Typically, the active compositions, formulations and methods of the present invention are also effective in decreasing the number of viable Diptera insect eggs which may be present in domestic animals or their environs.

More typically, a pour-on formulation of the present invention acts to control bot flies (Oestrus ovis) and blowflies (Lucilia, Calliphora, Chrysoniyia spp.) in sheep, acts to control similar flies in goats and camelids, acts to control flies (eg Musca domestica, Haenzatobia irritrans, Stomoxys calcitrans), and mosquitoes, on cattle and acts to control Dipterida (Culicoides spp, Simulium spp and other flies) in horses and Diptera pests in pigs.

The formulations of the present invention are prepared according to known techniques. Where the formulation is a solution the parasiticide/insecticide is mixed with the carrier or vehicle, using heat and stirring where required. Auxiliary or additional ingredients can be added to the mixture of active and carrier or can be mixed with the active prior to the addition of the carrier.

The formulations of the present invention can contain as little as lppm of each macrocyclic lactone compound and spinosyn compound per application and a synergistic effect is still observed.

The active compositions and formulations of the invention are non toxic to humans and animals as well as crops and plants, and residues in the wool, hides and tissue of animals treated with the formulations are at environmentally acceptable levels. Further no skin irritation or other toxicity to end users results from the method and formulations of this invention. Environmental contamination is also minimised.

Also advantageously, as such spinosyn factors and macrocyclic lactones are very efficacious at low levels due to their synergistic effect when combined together, the present invention is of utility against Diptera pest populations in domestic animals and their environs that have existing levels of resistance to both spinosyn compounds and macrocyclic lactones when these compounds are used separately.

Generally the administration of the formulations, and active compositions of the present invention is by way of surface/external application to structures or areas where domestic animals may be housed or proximally located and by way of externally/topically to the domestic animals. Such topical application can take the form of dipping, showering, jetting, spraying, manually applying such as dusting, or otherwise placing or laying the formulation containing the active substance/s. Accordingly, typically the active compositions of the invention are formulated into a number of topically applied insecticidal formulations.

Preferably such topical insecticidal formulations include spot-ons, pour ons, sprays, dips, dusts, lotions, gels, ointments, salves, dressings, towels, cremes, sticks, soaps, shampoos, collars, medallions, eartags and tail bands. Pour-on formulations including both aqueous and organic solvent based ones as well as emulsions and suspensions are preferred. As stated above, the formulations can be in a concentrated form which are diluted just prior to application.

More preferred are dip formulations, jetting fluid formulations and jetting/spray race formulations.

Wettable powders are another formulation of the invention which are prepared by blending the active with a dust carrier which wets and suspends in water. A surface active agent can be added. Sprays of wettable powders can be applied to the environs of domestic animals including poultry houses, stables, dairy sheds and pig pens because of their relative safety.

Emulsions are another formulation of the invention which are solutions of the active in water-immiscible organic solvents, commonly at 140%, with an optional surface active agent to promote emulsification, wetting and spreading. The choice of solvent is based on safety to plants, humans and animals, volatility, flammability and cost. Water emulsion sprays from such emulsion concentrates can be used in household Diptera pest control.

The spinosyn component of the active composition of the first aspect of the present invention may be present as a single compound, a mixture of two or more compounds, a mixture including at least one of A83543A and A83543D, or a mixture of at least one A83543 compound together with the dried portion of the fermentation medium in which it is produced.

The macrocyclic lactone compounds used in the present invention include such well known anthelmintic compounds as avermectins and milbemycins and derivatives and analogues thereof. As stated above, the avermectins are isolated from fermentation products of Streptomyces avennitilis and ivermectin is a compound which is a semisynthetic chemical formed by modification of avermectin. Commercially available ivermectin can include for example, the 25-isopropyl analogue of ivermectin. Avermectins being lipophilic can be prepared for the purposes of the formulations and methods of the present invention by dissolving an avermectin in an organic solvent such as chloroform, methylene chloride, acetone and alcohols. Milbemycins are other compounds which are not avermectins but which can be considered to come within the class of compounds which are macrocyclic lactones. The milbemycins differ structurally from the avermectin group, mainly in the absence of a disaccharide group on C-13.

The spinosyn compound may also be present as a salt in the active agent, formulations and methods of this invention. The salts would be prepared using standard procedures for salt preparation. For example, spinosyn A can be neutralised with an appropriate acid to form an acid additional salt. The acid addition salts of spinosyns which can be used in the present invention are useful and include salts formed by reaction with either an organic or inorganic acid such as, for example, sulfuric, hydrochloric, phosphoric, acetic, succinic, citric, lactic, maleic, fumaric, cholic, pamoic, mucic, glutamic, camphoric, glutaric, glycolic, phthalic, tartaric, formic, lauric, stearic, salicyclic, methanesulfonic, benzenesulfonic, sorbic, picric, benzoic, cinnamic and other like acids.

Generally, emulsifiable concentrates of the A83543 compounds comprise a convenient concentration of an A83543 compound dissolved in an inert carrier which is either a water-miscible solvent or a mixture of a water immiscible organic solvent and emulsifiers. A preferred concentration range is 1-500g/L of said spinosyn compound, more preferably the concentration range is selected from the group consisting of 1-400g/L, 1-350g/L, 1-300g/L, 1-250g/L, 1-200g/L, 1-150g/L, 1-100g/L, 1-90g/L, 1-80g/L, 1-70g/L, 160g/L, 1-50g/L, 140g/L, 1-30g/L, 1-20g/L, even more preferably 25g/L. Useful organic solvents include aromatics including xylenes and petroleum fractions. Other organic solvents may also be used, such as the terpenic solvents, including rosin derivatives, aliphatic ketones such as cyclohexanone and complex alcohols such as 2-ethoxyethanol.

Suitable emulsifiers for emulsifiable concentrates can be chosen from conventional nonionic surfactants, including ethylene oxide adducts of alkylphenols and anionic surfactants, including sulphonate alkyl/aryl salts.

Aqueous suspensions (AS) comprise suspensions of an active water-insoluble spinosyn compound dispersed in an aqueous vehicle at a concentration in the range of from about 1-500g/L, preferably the concentration range is selected from the group consisting of about 1400g/L, about 1-300g/L, about 1-250g/L, about 1-200g/L about 1-150g/IL, about 1-100g/L, about 1-50g/L, about 145g/L, about 140g/L, about 1-30g/L, more preferably about 25g/L. Generally the suspensions are prepared by finely grinding the spinosyn compound and mixing it into a vehicle comprised of water and surfactants chosen from such types as nonionic, sulfonated lignins and alkylsulfates. Inert ingredients may also be added.

The aqueous suspensions and emulsions are preferably diluted with water to obtain the desired spinosyn concentration in the final formulations of the invention.

In another preferred formulation, the one or more active substances take/s the form of a solution of the active/s in water. Sprays are the most common means of pesticide application on surfaces of structures such as stables, dairy sheds and pig pens. Sprays or dips are the most common means of pesticide application on small ruminant animal species with water generally as the principal carrier.

In the active composition and in the formulations of the present invention it is preferred that the spinosyn compound and the macrocyclic lactone compound are each present in a concentration of about 500 ppm or less. More typically, each are present in a concentration of about 400 ppm or less. Also typically, each are present in a concentration of about 300 ppm or less, more typically 200 ppm or less, even more typically 100 ppm or less, most typically 50 ppm or less.

### BEST MODE AND OTHER MODES OF PERFORMING THE INVENTION

Preparation of the preferred formulations of the present invention can be made by conventional processes, several examples of which are found below. The preferred process for preparing a spinosad and ivermectin combination of the present invention is to either co-formulate the combination or formulate each of the compounds separately then combine them together. The compounds could even exist in the combination as separate phases.

### EXAMPLES

Introduction

The macrocyclic lactones have a primary effect on the insect nervous system by activating inhibitory glutamate receptors, while spinosyns primarily activate the nicotinic acetylcholine receptors in insect neurones causing hyperactivity of neurones. However, both spinosyns and macrocyclic lactones have a secondary effect on gamma aminobutyric acid (GABA) gated chloride channels in insect neurones, GABA being an inhibitory neuro-transmitter. It is therefore possible that when combined spinosyns and macrocyclic lactones have a synergistic effect on the GABA receptor leading to effects in an insect's nervous system which would be unrelated to the primary effect of either spinosyns or macrocyclic lactones. The aim of this study was to test the hypothesis in Diptera pests of veterinary importance.

### Example 1

In-vitro Investigation for Possible Potentiation Between Spinosad and Ivermectin in Sheep Blowfly Larvae.

Materials and Methods

Forty to 50 newly hatched 1^{st} instar larvae of Lucilia cuprina were washed with sheep serum onto chromatography papers treated with serial dilutions of ivermectin or spinosad as set out below. After 48 hours numbers of live and dead larvae were counted. The LC90 was calculated for spinosad and ivermectin. Larvae were exposed to that concentration of spinosad or ivermectin and ½, ¼ and ⅛ of the LC90. In addition larvae were exposed to 1:1, 1:4, 4:1, 9:1 and 1:9 combinations of each chemical with each concentration of chemical being a fraction of the LC90.

There were 19 treatment groups in the study (plus an untreated control group):

A 1-4: Ivermectin alone at rates of 1×, 0.5×, 0.25× and 0.125×LC90

B 5-8: Spinosad alone at rates of 1×, 0.5×, 0.25× and 0.125×LC90

C 9-11: Equal rates of Ivermectin and Spinosad—(0.5×, 0.5×), (0.25×, 0.25×) and (0.125×, 0.125×)

D 12-14: Four:one rates of Ivermectin:Spinosad—(0.8×, 0.2×), (0.4×, 0.1×) and (0.2×, 0.05×)

E 15-17: Four:one rates of Spinosad:lvermectin—(0.8×, 0.2×), (0.4×, 0.1×) and (0.2×, 0.05×)

F 18,19: Ivermectin:Spinosad rates of (0.45×, 0.05×) and (0.05×, 0.45×)

Each group was tested on 4 replicates of 50 flies and the number of dead flies per replicate was recorded.

The method of generalized linear models for overdispersed binomial data using the logistic link function was used for an analysis of the 19 treatment groups. The analysis estimated dose-response lines (on the logarithmic dose scale) for each chemical or combination. The lines for each separate chemical were used to predict the efficacy (on the logistic scale) of the combinations assuming independent action, i.e. with no synergism. These were compared with the efficacy observed or predicted from the dose-response lines for the combinations.

Results

The efficacy estimates are given below, as sample means and as predictions from dose-response lines, on both the logistic and percentage scales. For the combinations predicted means assuming independent action are also provided. There was significant potentiation in most of the combinations tested. Potentiation was most pronounced using 4:1 and 9:1 ratios of spinosad: ivermectin.

| | Mean efficacy | | Mean efficacy | |
|---|---|---|---|---|
| Treatment | (Sample estimate) | | (Dose-response) | |
| (x LC90) | Logit | % | Logit | % |
| 1 Iv 1.0x | 2.75 ± 0.46 | 94.0 | 2.64 ± 0.34 | 93.3 |
| 2 Iv 0.5x | 0.38 ± 0.22 | 59.5 | 0.38 ± 0.18 | 59.4 |
| 3 Iv 0.25x | −2.09 ± 0.35 | 11.0 | −1.88 ± 0.26 | 13.2 |
| 4 Iv 0.125x | −3.48 ± 0.64 | 3.0 | −4.14 ± 0.48 | 1.6 |
| 5 Sp 1.0x | 2.38 ± 0.39 | 91.5 | 1.98 ± 0.27 | 87.9 |
| 6 Sp 0.5x | 0.53 ± 0.23 | 63.0 | 0.58 ± 0.16 | 64.1 |
| 7 Sp 0.25x | −1.27 ± 0.27 | 22.0 | −0.81 ± 0.17 | 30.7 |
| 8 Sp 0.125x | −1.66 ± 0.30 | 16.0 | −2.21 ± 0.28 | 9.8 |

| | Mean efficacy | | Mean efficacy | | Predicted efficacy | | | |
|---|---|---|---|---|---|---|---|---|
| Treatment | (Sample estimate) | | (Dose-response) | | (Independence) | | Difference | |
| (x LC90) | Logit | % | Logit | % | Logit | % | Logit | T-test |
| 9 Iv:Sp 0.5:0.5 | 2.51 ± 0.42 | 92 | 52.67 ± 0.37 | 93.5 | 1.77 ± 0.28 | 85.4 | 0.90 ± 0.46 | 1.96 (*) |
| 10 Iv:Sp 0.25:0.25 | 0.43 ± 0.22 | 60.5 | 0.34 ± 0.18 | 58.4 | −0.41 ± 0.17 | 39.8 | 0.75 ± 0.25 | 3.01 ** |
| 11 Iv:Sp 0.125:0.125 | −2.09 ± 0.35 | 11.0 | −1.99 ± 0.31 | 12.0 | −2.06 ± 0.32 | 11.3 | 0.08 ± 0.45 | 0.17 NS |
| 12 Iv:Sp 0.8:0.2 | 2.75 ± 0.46 | 94.0 | 2.64 ± 0.36 | 93.3 | 2.19 ± 0.32 | 90.0 | 0.45 ± 0.48 | 0.92 NS |
| 13 Iv:Sp 0.4:0.1 | 0.66 ± 0.23 | 66.0 | 0.72 ± 0.18 | 67.3 | −0.19 ± 0.18 | 45.2 | 0.92 ± 0.26 | 3.59 *** |
| 14 Iv:Sp 0.2:0.05 | −1.15 ± 0.26 | 24.0 | −1.19 ± 0.25 | 23.3 | −2.39 ± 0.35 | 8.4 | 1.20 ± 0.43 | 2.78 ** |
| 15 Sp:Iv 0.8:0.2 | 3.32 ± 0.60 | 96.5 | 3.32 ± 0.44 | 96.5 | 1.61 ± 0.26 | 83.4 | 1.71 ± 0.52 | 3.30 ** |
| 16 Sp:Iv 0.4:0.1 | 1.42 ± 0.28 | 80.5 | 1.42 ± 0.22 | 80.5 | 0.15 ± 0.15 | 53.6 | 1.27 ± 0.27 | 4.73 *** |
| 17 Sp:Iv 0.2:0.05 | −0.49 ± 0.23 | 38.0 | −0.49 ± 0.23 | 38.0 | −1.26 ± 0.25 | 22.1 | 0.77 ± 0.34 | 2.29 * |
| 18 Iv:Sp 0.45:0.05 | 0.85 ± 0.24 | 70.0 | — | — | 0.07 ± 0.17 | 51.7 | 0.78 ± 0.29 | 2.65 * |
| 19 Sp:Iv 0.45:0.05 | 1.77 ± 0.31 | 85.5 | — | — | 0.37 ± 0.19 | 59.2 | 1.40 ± 0.36 | 3.87 *** |

Note:
Significance levels: *** P < 0.001; ** P < 0.01; * P < 0.05; (*) P < 0.10; NS P > 0.10

Discussion

The results supported the hypothesis that spinosad and ivermectin potentiate the efficacy of each other, particularly when ivermectin is tie minor ingredient.

### Example 2

### In-Vitro Investigation for Possible Potentiation Between Spinosad and Ivermectin in Sheep Blowfly Larvae—Part II.

Materials and Methods

Solutions of spinosad, ivermectin, spinosad:ivernectin (1:1, 4:1 and 9:1) were prepared, serially diluted to concentrations expected to give from 0 to 100% mortality of blowfly larvae and used to treat chromatography papers. Forty or 50 newly hatched 1^{st} instar larvae of Lucilia cuprina were washed on to treated chromatography papers with fortified sheep serum. After 48 hours numbers of live and dead larvae were counted.

The data was assessed in 2 ways

1. Mortality was corrected for control mortality and analysed by Probit regresssion. LC50s were calculated and used to generate co-toxicity coefficients (Sun and Johnson, 1960 Analysis of joint action of insecticides against House flies. J Econ Entomol 53:887-892.).

2. Estimates of effective sample sizes were calculated using the method for the Wadley problem in Genstat. Estimates of dose response curves were calculated using the method of linear models for overdispersed binomial data using the logistic link function. LD50s were calculated and co-toxicity coefficients calculated. Curvature effects were not included in the first analysis to allow comparison with method 1.

Results.

The analysis using method 2 showed significant curvature for the 1;1 and 4:1 mixtures, which lead to lower LD50s and higher co-toxicity than when curvature was ignored.

| | | | Method 2 | | Curvature | |
|---|---|---|---|---|---|---|
| | Method 1 | | curvature ignored | | effect included | |
| | | CT | | CT | | CT |
| Chemicals | LC50 | coefficient | LD50 | coefficient | LD50 | coefficient |
| Ivermectin | 0.012 | | 0.0115 | | 0.0115 | |
| Spinosad | 0.102 | | 0.0843 | | 0.0799 | |
| 1:1 | 0.02 | 110 | 0.0191 | 106 | 0.0123 | 164 |
| 4:1 | 0.030 | 136 | 0.0291 | 128 | 0.0202 | 181 |
| 9:1 | 0.039 | 158 | 0.0399 | 130 | 0.0399 | 126 |

Discussion

Co-toxicity coefficients of 100 indicate additive action only. Values of 130 or higher indicate modest potentiation. Taking the curvature of the dose response lines into account a ratio of 4:1 spinosad:ivermectin gave maximum potentiation and the mixture was 4× more toxic than spinosad alone. The study confirmed the findings of synergy found in Example 1 using different methodology and analysis

Examples of the Spinosad Ivermectin (4:1) Synergistic Formulations to Control Diptera Pests

### Example 3

### Pour-On Formulation

| Ingredients | g/L |
|---|---|
| Spinosad | 20 |
| Ivermectin | 5 |
| antioxidant such as BHT | 0.5 |
| Crodamol IPM | 15 |
| Crodamol OSU | 15 |
| Crodamol OP | to 100% |

The formulation is applied to the dorsal midline of animals from the poll to the base of the tail using an applicator, usually a self filling dosing gun with a nozzle to dispense a narrow or wide band or lines of formulation along the back. The formulation is applied at 0.2 mL per kilogram body weight. Alternatively a set volume is applied to each bodyweight class—eg for sheep 10 mL for animals less than 30 kg, 15 for animals 31-50 kg and 20 ml for animals 51+kg. Sheep and other fibre producing animals should be treated within 24 hours of shearing or fibre collection.

### Example 4

Suspension concentrate, 20 g/L spinosad, 5 g/L ivermectin

The active chemicals are ground into fine particles using a bead mill.

| | % w/w |
|---|---|
| Spinosad | 2 |
| Ivermectin | 0.5 |
| Propylene glycol | 10 |
| Surfactant eg Pluronic P123 | 2 |
| Mineral thickener eg Veegum | 2 |
| Xanthum gum eg Rhodopol 23 | 0.2 |
| Antimicrobial eg Agent Dowicil 75 | 0.2 |
| Antifoam Agent eg Antifoam C | 0.1 |
| Water deionised | to 100% |

The suspension concentrate (SC) is diluted 1:1000 in water and used to fill a bath or dip. The chemical is applied to animals by immersing them. Alternatively a shower dip or jetting race can be used to wet animals to the skin. Sheep can be treated by using a hand jetting wand to pump the diluted chemicals into the wool. For wound dressings the diluted chemicals can be poured into a wound. A number of animal species can be treated by being sprayed with diluted product to control Diptera pests such as biting flies, mosquitoes and sandflies that plague domestic animals.

### Example 5

Emulsifiable concentrate 20 g/L spinosad, 5 g/L ivermectin

The active chemicals are ground into fine particles using a bead mill.

| | % w/w |
|---|---|
| Spinosad | 2 |
| Ivermectin | 0.5 |
| Antioxidant eg BHT | 0.5 |
| 10% of a blend of ionic and non ionic surfactants | |
| For example Toximul 3453F | 6.8 |
| Toximul 3454FA | 3.2 |
| Aromatic hydrocarbon solvent | |
| For example Solvesso 150 | to give 100% |

The emulsifiable concentrate (EC) is diluted 1:1000 in water and used to fill a bath or dip. The chemical is applied to animals by immersing them. Alternatively a shower dip or jetting race can be used to wet animals to the skin. Sheep can be treated by using a hand jetting wand to pump the diluted chemicals into the wool. For wound dressings the diluted chemicals can be poured into a wound. A number of animal species can be treated by being sprayed with diluted product to control Diptera pests that plague domestic animals.

### Example 6

Suspension concentrate 100 g/L spinosad, 25 g/L ivermectin

The active chemicals are ground into fine particles using a bead mill.

| | % w/w |
|---|---|
| Spinosad | 10 |
| Ivermectin | 2.5 |
| Propylene glycol | 10 |
| Surfactant eg Pluronic P123 | 2 |
| Mineral thickener eg Veegum | 2 |
| Xanthum gum eg Rhodopol 23 | 0.2 |
| Antimicrobial eg Agent Dowicil 75 | 0.2 |
| Antifoam Agent eg Antifoam C | 0.1 |
| Water deionised | to 100% |

The concentrate is diluted 1:1000 with water and sprayed onto the floor, walls and if necessary roofs of animal houses and premises to control flies and other Diptera insect pests.

For example; spraying the walls and roof of a dairy will control populations of biting flies that plague cattle during milking,

Spraying the walls of pig sheds will control mosquitoes and sandflies that bite pigs in summer and autumn in many areas of the world.

1. An active composition for controlling or eradicating Diptera pests in domestic animals or their environs, comprising a synergistic combination of at least one A83543 compound and at least one macrocyclic lactone.

2. The active composition as claimed in claim 1 wherein the ratio of A83543 compound:macrocyclic lactone is in the range of 10:1 to 1:10 w/w.

3. The active composition as claimed in claim 1 wherein the A83543 compound and the mactocyclic lactone compound are each present in a concentration of between about 1 ppm-500 ppm.

4. The active composition as claimed in claim 1 wherein said A83543 compound is selected from the group consisting of any spinosyn compound and salts thereof, and a mixture of any two or more spinosyn compounds including spinosad.

5. The active composition as claimed in claim 1 wherein said macrocyclic lactone is selected from the group consisting of ivermectin, abamectin, avermectin A₁ₐ, avermectin A_{1b}, avermectin A₂ₐ, avermectin A_{2b}, avermectin B₁ₐ, avermectin B_{1b}, avermectin B₂ₐ, avermectin B_{2b}, moxidectin, doramectin, selamectin, eprinomectin and milbemycin.

6. The active composition as claimed in claim 1 wherein said A83543 compound is spinosad and said macrocyclic lactone is ivermectin.

7. A formulation for controlling or eradicating Diptera pests in domestic animals or their environs, said formulation including an effective amount of an active composition as claimed in claim 1 and an acceptable carrier, diluent or excipient.

8. The formulation as claimed in claim 6 wherein the active composition is present in the formulation in a concentration of about 0.140% weight/volume.

9. The formulation as claimed in claim 6 wherein the Diptera pests are present in domestic animals.

10. The formulation as claimed in claim 8 wherein said formulation is externally applied to one or more domestic animals or their environs.

11. The formulation as claimed in claim 9 wherein said formulation is a topical formulation for applying to domestic animals, said topical formulation being selected from the group consisting of spot-ons, pour ons, sprays, dips, dusts, lotions, gels, ointments, salves, dressings, towels, cremes, sticks, soaps, shampoos, collars, medallions, eartags, dip formulations, jetting fluid formulations, jetting/spray race formulations and tail bands.

12. The formulation as claimed in claim 10 wherein said formulation is a pouron formulation applied to a localised area of the external surface of a domestic animal.

13. The formulation as claimed in claim 9 wherein about 0.1-2000 mg active agent/kg animal bodyweight is effective for topical application to domestic animals.

14. The formulation as claimed in claim 9 wherein said formulation is for applying to at least a localised area of an environ of a domestic animal, said formulation being selected from the group consisting of aerosol aprays, sprays of wettable powders, emulsions, water emulsion sprays and aqueous based solutions and suspensions.

15. A method of controlling or preventing Diptera pests in domestic animals, said method including the external application of an effective amount of an active composition as claimed in claim 1 or of a formulation as claimed in claim 2 to at least a localised area of the external surface of said animal.

16. A method of controlling or preventing Diptera pests in the environs of domestic animals, said method including the application of an effective amount of an active composition as claimed in claim 1 or of a formulation as claimed in claim 2 to a surface area of the environs.

17. Use of an active composition as claimed in claim 1 for the manufacture of a medicament for preventing or controlling Diptera pests in domestic animals or their environs.

18. An active composition as claimed in claim 1 or a formulation as claimed in claim 2 when used for preventing or controlling Diptera pests in domestic animals or their environs.
